(19) United States
(12) Patent Application Publication
(10) Pub. No.: US 2025/0332709 A1
(43) Pub. Date: Oct. 30, 2025

(54) CYCLOIDAL LEGS-AUGMENTED WHEELS FOR STAIR AND OBSTACLE CLIMBING IN MOBILE ROBOTS

(71) Applicant: The Texas A&M University System, College Station, TX (US)

(72) Inventors: Yuan Wei, College Station, TX (US); Kiju Lee, College Station, TX (US)

(73) Assignee: The Texas A&M University System, College Station, TX (US)

(21) Appl. No.: 19/192,820

(22) Filed: Apr. 29, 2025

Related U.S. Application Data
(60) Provisional application No. 63/640,197, filed on Apr. 29, 2024.

(51) Int. Cl. B25J 5/00; B25J 9/00; B25J 9/10

(52) U.S. Cl. CPC B25J 5/007; B25J 9/0009; B25J 9/106

(57) ABSTRACT

A leg-augmented wheel assembly includes a wheel, a plurality of leg members, each leg member of the plurality of leg members comprising a first end connected to the wheel, and a plurality of links, each link comprising a first end connected to one leg member of the plurality of leg members and a second end connected to each other second end of the plurality of links.

### CROSS-REFERENCE TO RELATED APPLICATIONS

This patent application claims priority from, and incorporates by reference the entire disclosure of, U.S. Provisional Patent No. 63/640,197 filed on Apr. 29, 2024.

### STATEMENT REGARDING FEDERALLY SPONSORED RESEARCH

This invention was made with government support under Award No. 2021-67021-35959 awarded by the USDA-National Institute of Food and Agriculture. The government has certain rights in the invention.

### TECHNICAL FIELD

The present disclosure relates generally to mobile robots, and more particularly, but not by way of limitation to cycloidal leg-augmented wheels for stair and obstacle climbing in mobile robots.

### BACKGROUND

This section provides background information to facilitate a better understanding of the various aspects of the disclosure. It should be understood that the statements in this section of this document are to be read in this light, and not as admissions of prior art.

Stairs provide humans access to different heights and spaces, but they pose a significant challenge for ground mobile robots. Although various locomotion systems exist, wheels are predominantly favored for mobile robotic systems due to their inherent mechanical and structural simplicity, power efficiency, well-established kinematics, affordability, and ease of control. However, the mobility of wheeled robots is influenced by wheel size, and the maximum climbable obstacle height is typically smaller than the wheel's radius (r). Using larger wheels on a larger chassis may enable movement across stairs and rough terrains, but it leads to a bulkier and heavier robot. Additionally, practical and physical limitations come into play. For example, many indoor staircases are often narrow, making it impossible for a robot with a large body and wheels to navigate them.

Legged robots exhibit versatility in obstacle and stair climbing compared to wheeled robots. Several quadruped and hexapod robots have demonstrated their agile mobility across various environments, including stairs. However, most existing legged robots tend to be mechanically and structurally more complex than wheeled ones. Many of these robots consume more power and require sophisticated control strategies to address stability issues. As a result, legged robots are often significantly more expensive than their wheeled counterparts. Wheel-legged robots have employed spoke-like legs to achieve versatile mobility while maintaining their control and operation as simple as wheeled robots. However, these spoke-like legs generate significant vibrations, posing an increased risk of hardware failure and errors in sensor readings. Therefore, such wheel-leg mechanisms are typically adopted only for small and lightweight mobile robots.

Previous works have also explored innovative strategies to combine wheels and legs to achieve structural and control simplicity, smooth rolling ability, and obstacle-climbing capability. Some of these mechanisms are transformable, capable of switching between a circular wheel shape and a leg-like configuration to adapt to different terrains. In some instances, the wheel-leg transformation can be actively controlled using one or more designated actuators. In such active mechanisms, the transformation can be precisely controlled based on the terrain conditions. However, additional actuators increase the weight and overall complexity of the robot.

Some transformable mechanisms rely on passive wheel-leg transformation triggered by external conditions. For instance, in passive systems, the wheel-leg transformation is triggered by external friction force, the triggering of which is affected by design variables. In fixed-axis, four-wheeled robots—a common configuration adopted for mobile robots and small Unmanned Ground Vehicles (UGVs)—equipped with passively transformable wheels, turning or moving on a curve may cause different friction applied to the left and right sides of the wheels. This can result in the wheels on one side changing into the legged configuration while the other remains in the wheeled configuration. If the robot moves in a complex environment requiring frequent turning, it loses its capability to roll smoothly, even on a flat surface. The increased vibrations due to unwanted wheel-leg transition leads to an increased risk of hardware damage.

Another design approach is to mechanically integrate the two features of wheels and legs. These robots behave like legged robots when climbing obstacles and roll with wheels on flat surfaces. These mechanisms require precise control to maintain the overall balance. Some wheel-leg integrated designs do not involve additional actuation or control needs. However, those designs exhibit a relatively low climbing capability. Their maximum climbable obstacle height is about the same or lower than the diameter of the closed wheel.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In some aspects, a leg-augmented wheel assembly includes a wheel, a first leg member comprising a first end connected to the wheel, and a first link comprising a first end connected to the first leg member, the connection of the first link to the leg first member being configured to periodically extend the first leg member as the wheel rotates.

In some aspects, the first leg member comprises a second end configured to extend outward from the wheel boundary as the wheel rotates to traverse obstacles encountered by the wheel. In some aspects, the second end of the first leg member is configured to retract to a radius less than or equal to the radius of the wheel at a point where the wheel contacts a surface upon which the wheel rotates. In some aspects, the first end of the first link connects to the first leg member at a point between the first leg member's first and second end.

In some aspects the second end of the first leg is configured to extend greater than two times the diameter of the wheel.

In some aspects, the augmented wheel assembly includes second and third leg members, and second and third links. The second link comprises a first end connected the second leg member, the third link comprises a first end connected to the third leg member, and second ends of the first, second, and third links are connected together.

In some aspects, a leg-augmented wheel assembly includes a plurality of links, a plurality of leg members, each leg member of the plurality of leg members comprising a first end connected to a link of the plurality of links and a second end comprising a curved edge that is configured to allow a wheel of the wheel assembly to make contact with a surface upon which the leg-augmented wheel assembly rotates during a portion of a cycloidal rotation of the leg member. Each link comprises a first end connected to one leg member of the plurality of leg members and a second end connected to each other link of the plurality of links.

In some aspects, the second end of each leg member comprises a portion configured to extend outward from a boundary of the wheel as the wheel rotates to traverse obstacles encountered by the wheel.

In some aspects, the second end of each leg member is configured to retract to a radius less than or equal to the radius of the wheel at a point where the wheel contacts a surface upon which the wheel rotates.

In some aspects, the portion is configured to extend beyond the twice of the length of an arm of the plurality of arms.

In some aspects, a mobile robot includes a plurality of the leg-augmented wheel assemblies described herein.

In some aspects, a leg-augmented wheel assembly includes a wheel, at least one leg member, each leg member comprising a first end connected to the wheel, and a link for each leg member, each link comprising a first end connected to one leg member of the at least one leg member and a second end connected to one of a second end of an additional link or the wheel.

In some aspects, the at least one leg member comprises a second end configured to extend outward from the wheel as the wheel rotates to traverse obstacles encountered by the wheel. In some aspects, the second end of the at least one leg member is configured to retract to a radius less than or equal to the radius of the wheel at a point where the wheel contacts a surface upon which the wheel rotates.

In some aspects, the second end is configured to extend greater than two times the diameter of the wheel.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIGS. 1A, 1B and 1C illustrate multiple views of a four-wheel skid-steering mobile robot equipped with CLAW mechanisms, according to aspects of the disclosure.

FIGS. 2A, 2B, 2C and 2D illustrate a range of motion of an arm of a cycloidal legs-augmented wheel (“CLAW”) mechanism, according to aspects of the disclosure.

FIGS. 3A and 3B are coordinate diagrams of a CLAW mechanism when the robot is (FIG. 3A) moving on a flat surface and (FIG. 3B) climbing stairs, according to aspects of the disclosure.

FIGS. 4A, 4B, 4C and 4D illustrate two stuck cases (FIGS. 4A and 4B), and the configurations after adding proper constraints shown in (FIGS. 4C and 4D for each case, respectively), according to aspects of the disclosure.

FIG. 5A is a graph illustrating trajectory of a leg tip in f₀ and FIG. 5B is a graph illustrating a maximum effective height of the tip with an equivalent moment arm for stall torque over β, according to aspects of the disclosure.

FIGS. 6A and 6B are free body diagrams of external forces acting on a four-wheel skid-steering mobile robot (FIG. 6A) and on a CLAW mechanism (FIG. 6B), according to aspects of the disclosure.

FIG. 7 is a side view of a three-leg version of a CLAW mechanism illustrating trajectory of the leg tips, according to the disclosure.

FIG. 8 is a system diagram of a four-wheel skid-steering mobile robot, according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provide support for such embodiments. However, it should be noted that the disclosure below is for illustrative purposes only and is not intended to limit the scope of the claimed subject matter in any way.

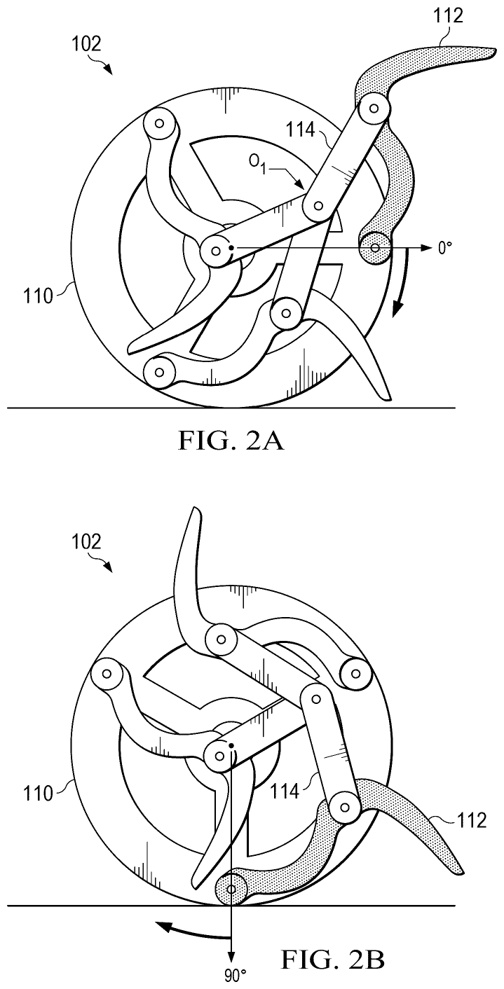

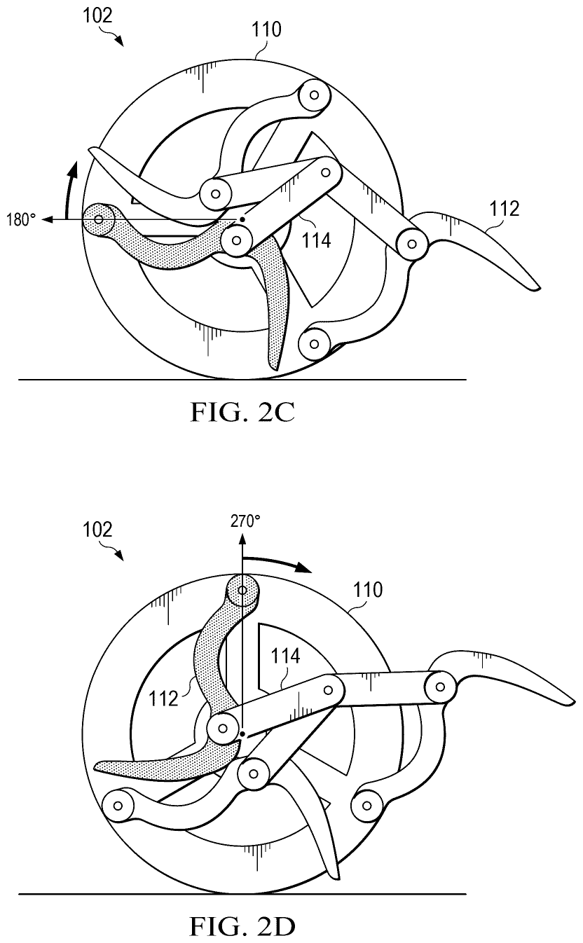

A CLAW mechanism, as shown and described herein, is a passive wheel-leg integrated mechanism that, in one aspect, combines a wheel with multiple legs that follow cycloidal trajectories as the wheel rotates (e.g., see FIGS. 2A-2D, FIG. 5A, and FIG. 7), and in another aspect uses the multiple legs in a cycloidal trajectory to both climb obstacles and act as wheel (e.g., see FIGS. 2A-2D). These designs guarantee smooth rolling on flat surfaces—overcoming the uncertainty of wheel-leg transformation behavior in passive transformable mechanisms—and climbing ability on rough terrains and stairs. A four-wheeled robotic platform equipped with the CLAW mechanisms experimentally verifies the numerical optimization and further validates the CLAW mechanism's locomotion capabilities-smooth rolling on flat surfaces and climbing obstacles and stairs. The CLAW mechanism discussed herein provides various advantages, including, but not limited to: 1) application-specific design customization; 2) the CLAW mechanism retains the operational and control simplicity of conventional wheels without requiring additional actuators; 3) a mobile robot equipped with the CLAW mechanisms demonstrates high climbing ability, 2.6 times its wheel radius (1.3 times its wheel diameter); 4) the CLAW mechanism ensures smooth rolling on flat surfaces while utilizing the extended legs to overcome obstacles; 5) the CLAW mechanism can be an add-on to existing wheeled robots that can be integrated with minor modifications to improve obstacle-climbing capabilities.

The design of the CLAW mechanism involves several design variables and parameters that determine the cycloidal motion of the leg as the wheel rotates. This section considers a single leg attached to a circular wheel to describe the optimization process, while the actual CLAW mechanism later adopts a three-leg structure. This section introduces the design variables and parameters and numerical optimization procedures to maximize the climbing capability given the wheel size and the maximum slope of the terrain (or the maximum pitch angle of the robot).

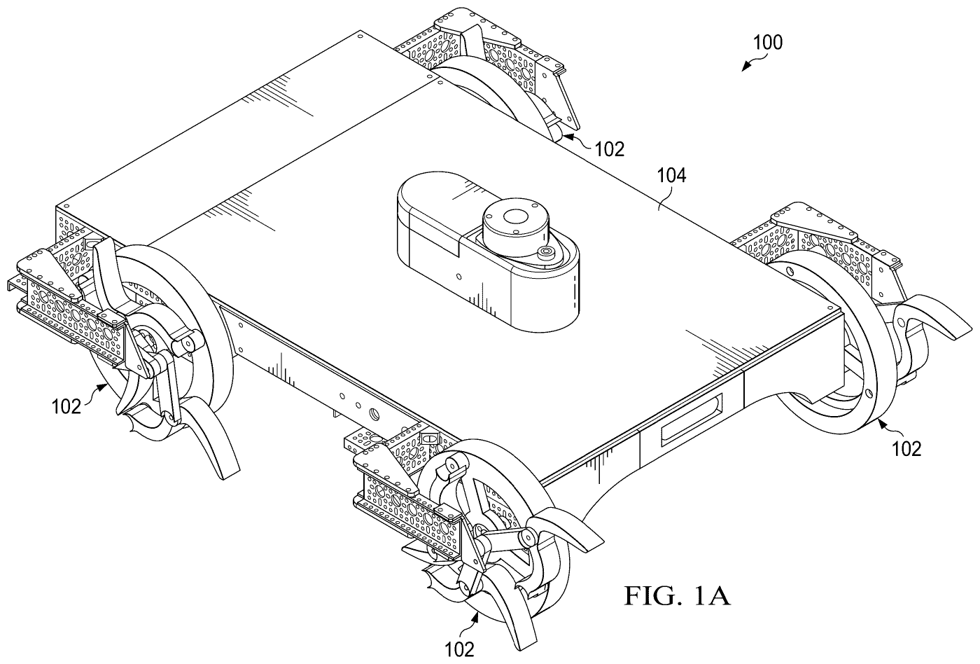

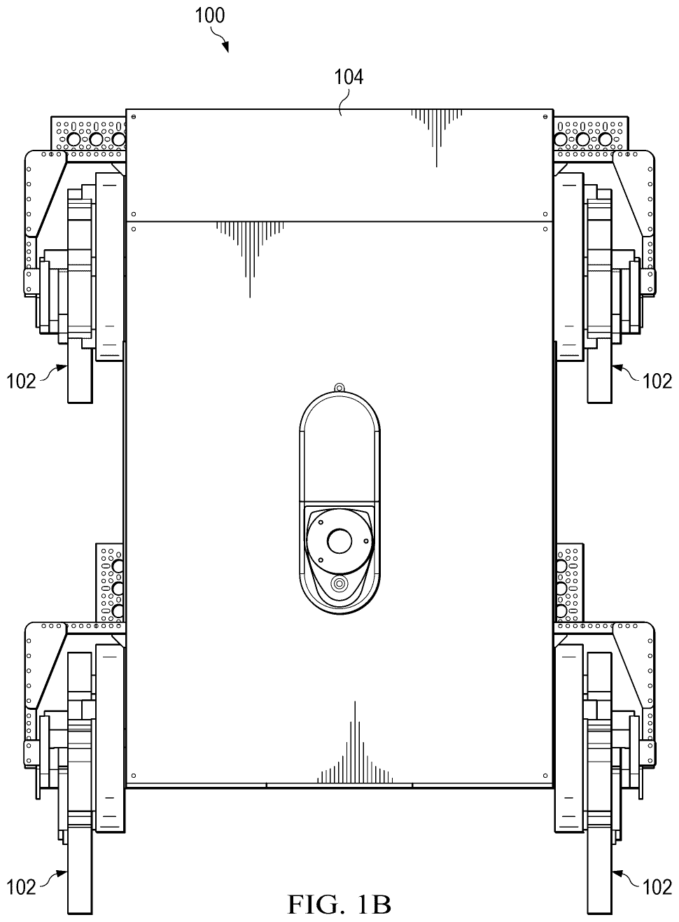

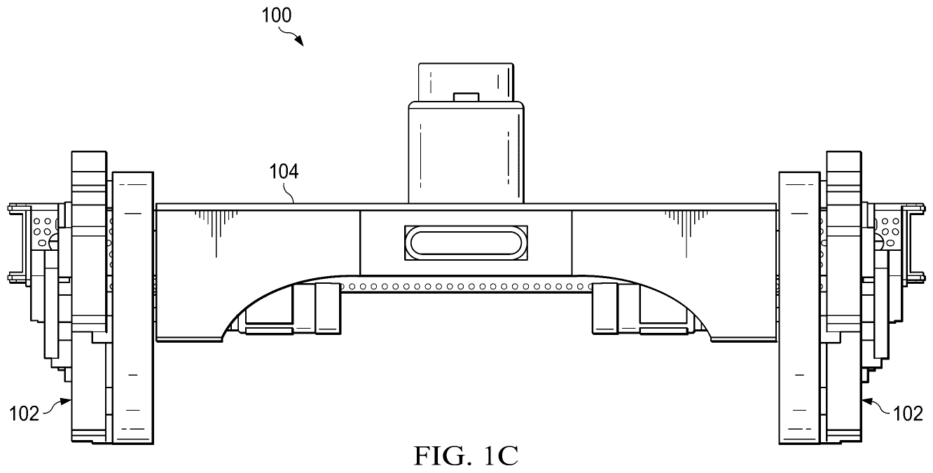

FIGS. 1A-1C illustrate a mobile robot 100 that includes a plurality of CLAW mechanisms 102. As shown, robot 100 includes four CLAW mechanisms 102 attached to a chassis 104. Chassis 104 serves as a frame and housing to which various components of robot 100 are secured. For example, chassis 104 may house motors to drive the plurality of CLAW mechanisms 102, an IMU, GPS sensors, Lidar sensors and the like.

FIGS. 2A-2D illustrate a cycle of motion of one CLAW mechanism 102. Each mechanism 102 includes a wheel 110 to which a plurality of legs 112 are movably attached. Each leg 112 is pivotably secured at a first end to wheel 110 near a periphery of wheel 110, and is pivotably secured at a second point disposed between the first end and a second end of leg 112 to one linkage 114 of a plurality of linkages 114. The number of linkages 114 is equal to the number of legs 112, the number of which can be varied. Each linkage 114 is connected at a first end to a leg 112 as noted previously, and at a second end to each second end of the remaining linkages 114. This configuration creates the movement of legs 112 as illustrated in FIGS. 2A-2D.

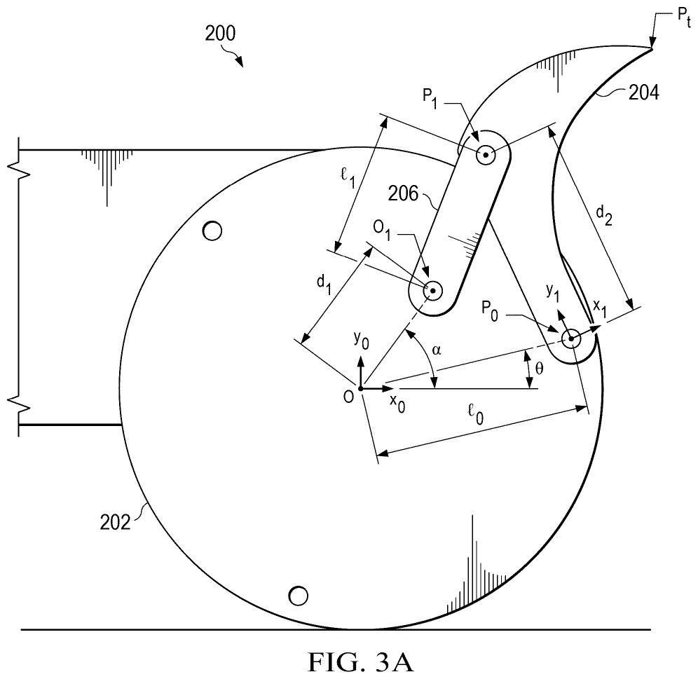

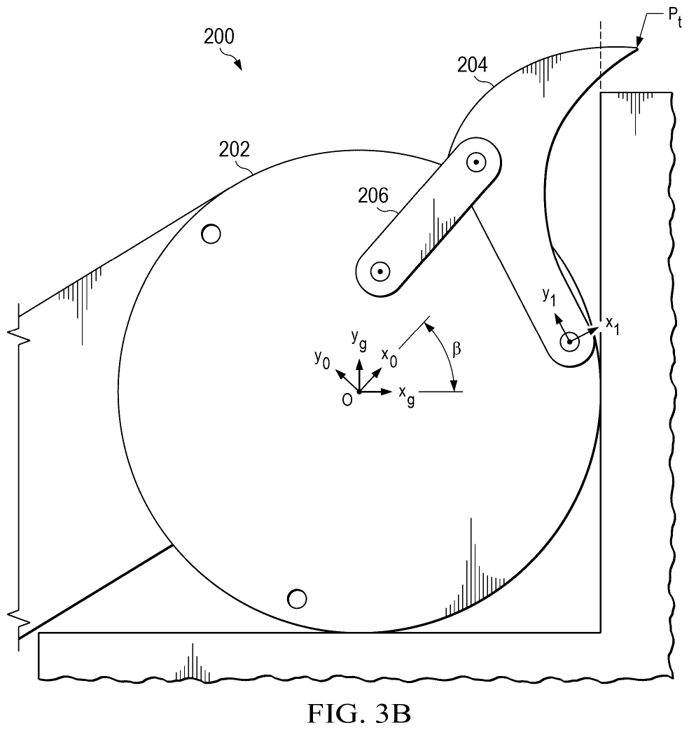

FIGS. 3A and 3B are coordinate diagrams of a CLAW mechanism 200. CLAW mechanism 200 may be used with, for example, robot 100. FIG. 3A illustrates a scenario in which the robot is moving on a flat surface, and FIG. 3B illustrates a scenario in which the robot is climbing an obstacle (e.g., stairs, rough terrain, and the like). Mechanism 200 includes a wheel 202, a plurality of legs 204 (one leg 204 is shown for clarity purposes), and a plurality of linkages 206 (one linkage 206 is shown for clarity purposes). The shape of leg 204 is different than the shape of leg 112, which is a matter of design/use preference. Joints O and O₁ are fixed in the robot's base frame f₀. Joint P₀ moves with wheel 202 rotating about O with the angle θ. Linkage 206 (represented by)O̅₁̅P̅₁̅ rotates about O₁. Wheel 202 and linkage 206 O̅₁̅P̅₁̅ are connected to leg 204 through joints P₀ and P₁, respectively. Since O and O₁ are fixed, the angle α remains constant as wheel 202 rotates. The frame f₁ is attached to leg 204 at P₀, and the coordinate of the tip of leg 204 in f₁ is expressed as Equation (1):

$${}^{1} {P}_{t} = {[ {}^{1} {x}_{t} , {}^{1} {y}_{t} , 0 ]}^{T} \qquad Eq . ( 1 )$$

Table 1 lists (a) all design variables with boundary conditions and (b) parameters. The variable vector x is defined by Equation (2):

$$x = {[ {l}_{0} , {d}_{1} , {l}_{1} , {d}_{2} , {}^{1} {x}_{t} , {}^{1} {t}_{t} , ∝ ]}^{T} \qquad Eq . ( 2 )$$

TABLE 1
List of Design Variables and User-Specified Parameters

| Variable | Description | Boundary Conditions |
|---|---|---|
| l₀ | Length of O̅₁̅P̅₀̅ | 0 < l₀ < r − δr |
| d₁ | Length of O̅O̅₁̅ | 0 < d₁ < r − δr |
| l₁ | Length of O̅₁̅P̅₁̅ | 0 < l₁ < r − δr |
| d₂ | Length of P̅₀̅P̅₁̅ | 0 < d₂ < r − δr |
| ¹xₜ | x coordinate of point Pₜ in f₁ | δr < ¹xₜ < 2r |
| ¹yₜ | y coordinate of point Pₜ in f₁ | δr < ¹yₜ < 2r |
| α | Angle between x₀ and O̅O̅₁̅ | $- \frac{π}{2} < α < π$ |
| | Parameter | Description |
| | r | Wheel radius |
| | βₘₐₓ | Maximum body slope |

The variables d₁ and a locate the position of O₁, and l₀, l₁, and d₂ determine lengths of linkages 206. The coordinates ¹xₜ and ¹yₜ expressed in f₁ simplify the design process when creating the computer-aided design (CAD) model for leg 204. Radius r of wheel 202 is considered a parameter to ensure compatibility with other universal wheels because all given variables and boundary conditions are expressed in terms of r after optimization. This allows users to easily customize the size of wheel 202 and find the corresponding optimal variables. The maximum body slope βₘₐₓ is another parameter determined by the target environments. This value sets the robot's maximum pitch angle, accounting for obstacle climbing or moving on a slopped terrain.

### Single-Objective Design Optimization

This optimization aims to find an optimal set of design variables for the wheel to achieve the maximum obstacle-climbing ability, given r and βₘₐₓ. In this process, a right-angled obstacle is considered where robot 100 is on a slope, as illustrated in FIG. 3B. Climbing an obstacle on a slope is often more challenging than on a flat surface. Such capability is particularly important for stair climbing. Robots capable of stair climbing typically show versatile multi-terrain mobility. In FIG. 3B, the robot is on a pitch angle β. For the robot to traverse diverse stairs reliably, it is preferable for Pₜ to reach as high as possible, while its horizontal position passes the dashed vertical line to engage the obstacle effectively.

The coordinate of Pₜ in f_{g} is given by ^{g}Pₜ=[^{g}xₜ, ^{g}yₜ, 0]^{T}. The objective function to maximize the tip height can then be defined as Equation (3):

$$Z = \frac{max}{x} {}^{g} {y}_{t} ( x ) \qquad Eq . ( 3 )$$

The position of ^{g}Pₜ is obtained by Equation (4):

$$[ \frac{{}^{g} {P}_{t}}{1} ] = {T}_{0}^{g} {T}_{1}^{0} [ \frac{{}^{1} {P}_{t}}{1} ] \qquad Eq . ( 4 )$$

where T^{g} and T⁰ are the transformation matrices from f_{g} to f₀ and f₀ to f₁, respectively. The matrix T₀^{g} is given by Equation (5):

$${T}_{0}^{g} = [ \begin{matrix}cos β & - sin β & 0 & 0 \\ sin β & cos β & 0 & 0 \\ 0 & 0 & 1 & 0 \\ 0 & 0 & 0 & 1\end{matrix} ] \qquad Eq . ( 5 )$$

We can express T₀^{g} in the following Equation (6):

$${T}_{1}^{0} = [ \begin{matrix}{\hat{x}}_{1} & {\hat{y}}_{1} & {\hat{z}}_{1} & {}_{}^{0} {P}_{0}^{} \\ 0 & 0 & 0 & 1\end{matrix} ] \qquad Eq . ( 6 )$$

where \hat{x}₁, ŷ₁, and \hat{x}₁ are unit vectors of the axes of f₁ with respect to f₀. \hat{x}₁, ŷ₁, and ⁰P₀ are obtained following the steps described below.

Referring to FIG. 3A, the coordinates of the joints in f₀ are:

$${}_{}^{0} {O}_{1}^{} = {[ {d}_{1} cos α , {d}_{1} sin α , 0 ]}^{T}$$

$${}_{}^{0} {P}_{0}^{} = {[ {l}_{0} cos θ , {l}_{0} sin θ , 0 ]}^{T}$$

$${}_{}^{0} {P}_{1}^{} = {[ {x}_{P 1} , {y}_{P 1} , 0 ]}^{T}$$

And the following relationships in Equations (7) and (8):

$${( {x}_{P 1} - {d}_{1} cos α )}^{2} + {( {y}_{P 1} - {d}_{1} sin α )}^{2} = {l}_{1}^{2} \qquad Eq . ( 7 )$$

$${( {x}_{P 1} - {l}_{0} cos θ )}^{2} + {( {y}_{P 1} - {l}_{0} sin θ )}^{2} = {d}_{2}^{2} \qquad Eq . ( 8 )$$

Using the above, the solution for x_{P}_{₁} and y_{P}_{₁} can be derived, as detailed in Equations (28)-(40) discussed below. The unit vector ŷ₁ in f₀ becomes, as shown in Equation (9):

$${\hat{y}}_{1} = \frac{\overline{{P}_{0} {P}_{1}}}{\vert {P}_{0} {P}_{1} \vert} = {\frac{1}{{d}_{2}} [ {x}_{P 1} - {l}_{0} cos θ , {y}_{P 1} - {l}_{0} sin θ , 0 ]}^{T} \qquad Eq . ( 9 )$$

Let t₁=(x_{P}_{₁}−l₀ cos θ)/d₂ and t₂=(y_{P}_{₁}−l₀ sin 0)/d₂, then the above becomes as shown in Equation (10):

$${\hat{y}}_{1} = {[ {t}_{1} , {t}_{2} , 0 ]}^{T} \qquad Eq . ( 10 )$$

Since \hat{x}₁ must be perpendicular to ŷ₁ following the right-handed rule, Equation (11):

$${\hat{x}}_{1} = {[ {t}_{2} , - {t}_{1} , 0 ]}^{T} \qquad Eq . ( 11 )$$

By plugging (5) back to (4), ^{g}Pₜ can be expressed in terms of x and the rotation angle θ. Therefore, the expression ^{g}yₜ(x, θ) in the objective function can be obtained.

The remaining unknown symbol θ must be solved for given x. The horizontal coordinate of the leg tip must be greater than the radius of the wheel to properly make contact with the next step. This means that ^{q}xₜ(x, θ)>r. With given x in each step of the optimization, Equation (3) becomes Equation (12):

$$Z = {{max}^{g}}_{θ} yt ( x , θ ) \qquad Eq . ( 12 )$$

While, in Equation (13):

$${}_{}^{g} {x}_{t}^{} ( x , θ ) > r \qquad Eq . ( 13 )$$

The solution can be found by taking a partial derivative of Equation (13) with respect to θ, and then θ is expressed as a function of x. However, ^{g}yₜ(x, θ) involves many nonlinear terms, which make it difficult to find the derivative analytically. A numerical method was applied by sampling n evenly spaced points for θ∈(−π, π) and evaluating the function values at these points. Given a set θ={θ₁, θ₂, . . . , θₙ}, there is an optimal θ*, such that ^{g}xₜ(x, θ*)>r, and for any θₜ in θ that satisfies ^{g}xₜ(x, θᵢ)>r and ^{g}yₜ(x, θ*)≥^{g}yₜ(x, θᵢ). Equation (13) is added to nonlinear constraints below to ensure θᵢ satisfying ^{g}xₜ(x, θᵢ)>r exists, and ^{g}yₜ(x, θ*(x)) becomes the final expression of the objective function.

### Constraints

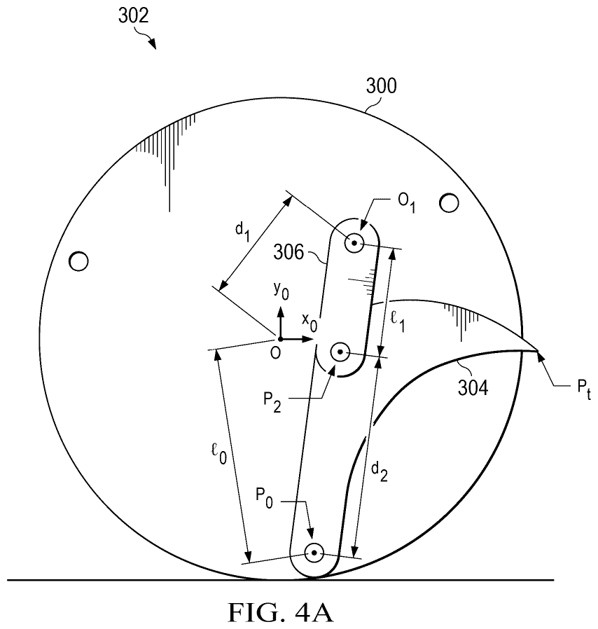

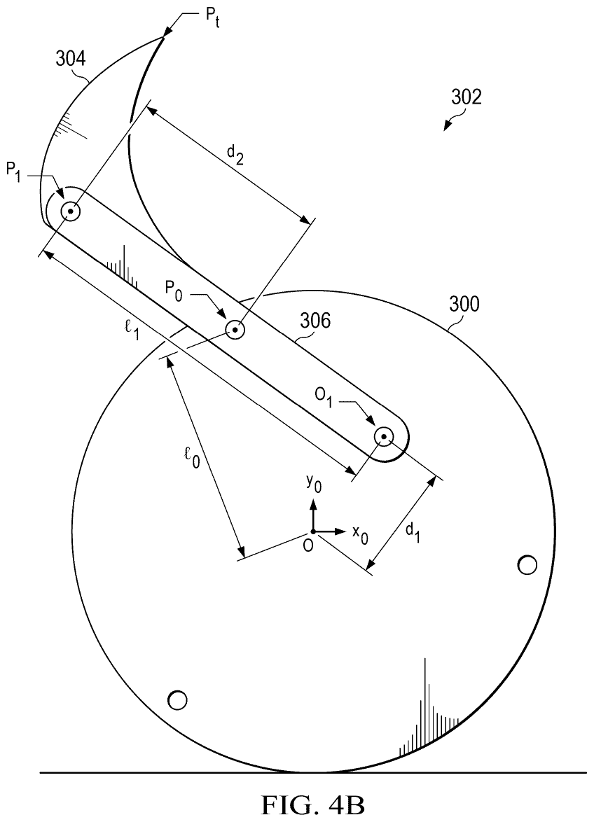

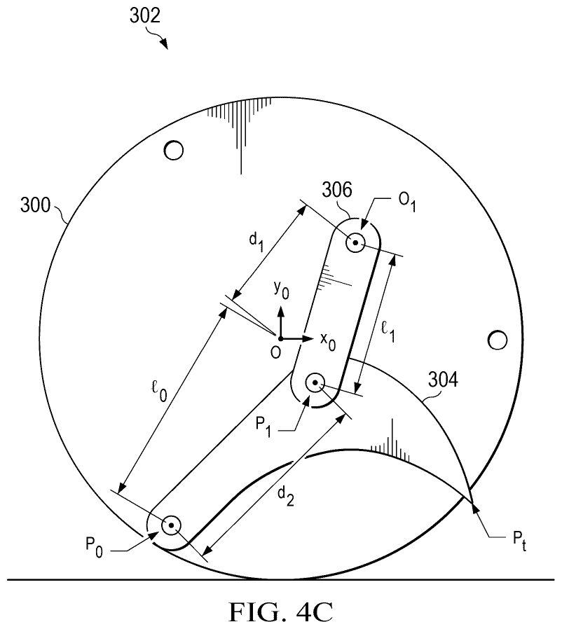

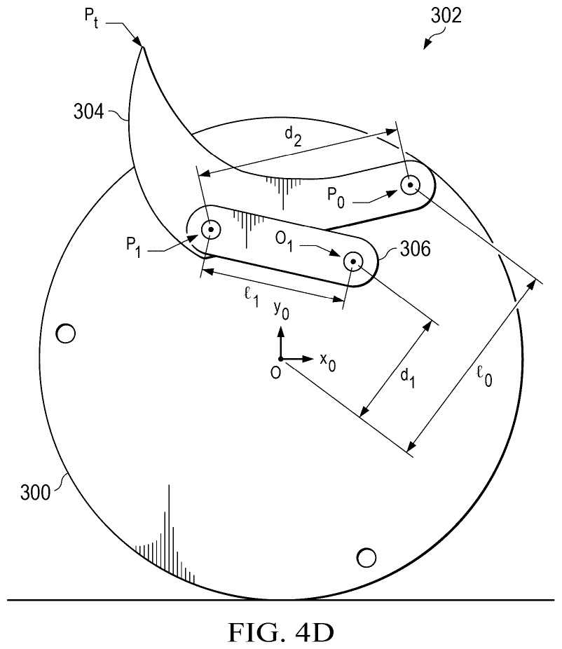

Linear constraints are defined to ensure continuous rotation of the wheel. The Grashof condition for a planar quadrilateral linkage was used to form the constraints equations. FIGS. 4A-4D illustrate a wheel 300 at four different points of rotation. Wheel 300 includes a CLAW mechanism 302 having a leg 304 and a linkage 306. FIG. 4A shows O̅₁̅P̅₁̅ and P̅₀̅P̅₁̅ are on the same line. The distance between O₁ and P₀ can no longer extend as the wheel rotates clockwise. To avoid this situation, the summation of P̅₁̅O̅₁̅ and P̅₁̅P̅₀̅ must be greater than the summation of O̅₁̅O̅ and O̅P̅₀̅, as illustrated in FIG. 4C. This constraint can be expressed as Equation (14):

$${l}_{1} + {d}_{2} - {l}_{0} - {d}_{1} > δ r \qquad Eq . ( 14 )$$

A safety factor δr is added to all constraints.

In another case shown in FIG. 4B, P̅₁̅O̅₁̅ and P̅₁̅P̅₀̅ coincide with each other. When wheel 300 rotates clockwise at this critical point, P̅₁̅O̅₁̅ can rotate clockwise or counterclockwise. This leads to two distinct trajectories, and this situation should be avoided. To address this issue, the structure must be maintained in the structure depicted in FIG. 4D. The associated constraints are expressed as Equations (15) and (16):

$${l}_{1} - {d}_{2} + {l}_{0} - {d}_{1} > δ r \qquad Eq . ( 15 )$$

$${d}_{2} - {l}_{1} + {l}_{0} - {d}_{1} > δ r \qquad Eq . ( 16 )$$

One nonlinear constraint is introduced to prevent leg 304 from touching the ground when the robot operates on smooth and flat ground. Given x, the lowest point ⁰yₜ(x, θₘ) must be higher than the ground level. For any θᵢ in the set θ, ⁰yₜ(x, θₘ)≤⁰yₜ(x, θᵢ). This nonlinear constraint is defined as Equation (17):

$${}_{}^{0} {y}_{t}^{} ( x , {θ}_{m} ) > - r + δ r \qquad Eq . ( 17 )$$

Another nonlinear constraint is to ensure that

$${}_{}^{g} {x}_{t}^{} ( x , θ ) > \frac{D}{2} exists .$$

Defining θᵣ, such that for any θᵢ in set θ, ^{g}xₜ(x, θᵣ)≥^{g}xₜ(x, θᵢ), this nonlinear constraint is defined as Equation (18):

$${}_{}^{g} {x}_{t}^{} ( x , θ ) > r \qquad Eq . ( 18 )$$

### Numerical Results

The MATLAB nonlinear programming solver ‘fmincon’ was applied for this optimization problem. This solver finds the minimum value of the objective function, and therefore, a negative sign on the objective function was added as Equation (19):

$$f ( x ) = - {}_{}^{g} {y}_{t}^{} ( x , {θ}^{*} ( x ) ) \qquad Eq . ( 19 )$$

The constraints were set with the safety factor δ=2%. The linear and nonlinear constraints in (13)-(17) were applied. The optimization also considered the boundary conditions listed in Table 1, with βₘₐₓ=π/4 and r=50. This maximum pitch angle βₘₐₓ was selected to be slightly higher than the slope of common staircases. The value for r was set without a unit temporarily. 100 samples were used for θ. The specific algorithm used was ‘fmincon Interior-Point’ with the step tolerance of 1×10⁻²⁰ and the function tolerance of 1×10⁻¹⁰. The function used different initial values, and the corresponding numerical results were found, as listed in Table 2.

TABLE 2
List of Optimization Results with Different Initial Value of x

| Trial Number | Initial Value of x | Feasible Output |
|---|---|---|
| 1 | [40, 14, 34, 33, 16, 50, 0.6188] | −39.00 |
| 2 | [42, 19, 35, 30, 14, 44, 0.3142] | −55.17 |
| 3 | [40, 10, 33, 12, 15, 62, 0.3142] | −53.18 |
| 4 | [38, 15, 26, 31, 5, 79, 0.1366] | −48.80 |
| 5 | [45, 30, 36, 40, 30, 30, 0.0000] | −91.43 |
| 6 | [23, 16, 22, 21, 14, 37, 0.2856] | 0.00 |
| 7 | [23, 16, 22, 21, 5, 37, 0.2856] | −20.22 |
| 8 | [40, 12, 32, 28, 12, 60, 0.0551] | −49.93 |
| 9 | [45, 15, 31, 30, 8, 55, 0.1822] | −51.26 |
| 10 | [43, 11, 23, 31, 9, 84, −0.7985] | −13.57 |

The primary focus of this optimization is to find a locally optimal and feasible design solution that can be implemented in a physical design. The numerical solutions do not guarantee global optimality. The best result among the solutions listed in Table 2 was Trial 5, where the corresponding x* was found by Equation (20):

$${x}^{*} = [ 44.58 , 29.59 , 32.57 , 42.43 , 39.21 , 61.14 , 0.4595 ] \qquad Eq . ( 20 )$$

The design variables are expressed as l₀=0.8916r, d₁=0.5918r, l₁=0.6514r, d₂=0.8486r, ^{f}^{₁}xₜ=0.7842r, and ^{f}^{₁}yₜ=1.223r. The angle α is 0.4595) radian (26.33°). The maximum obstacle height h* that the robot can reach when operating at βₘₐₓ is shown in Equation (21):

$${h}^{*} = - f ( {x}^{*} ) + r = - ( - 91.43 ) + 50 = 141.43 \qquad Eq . ( 21 )$$

This means that the actual value of h* is 2.8286r.

### Evaluation of Optimization Results

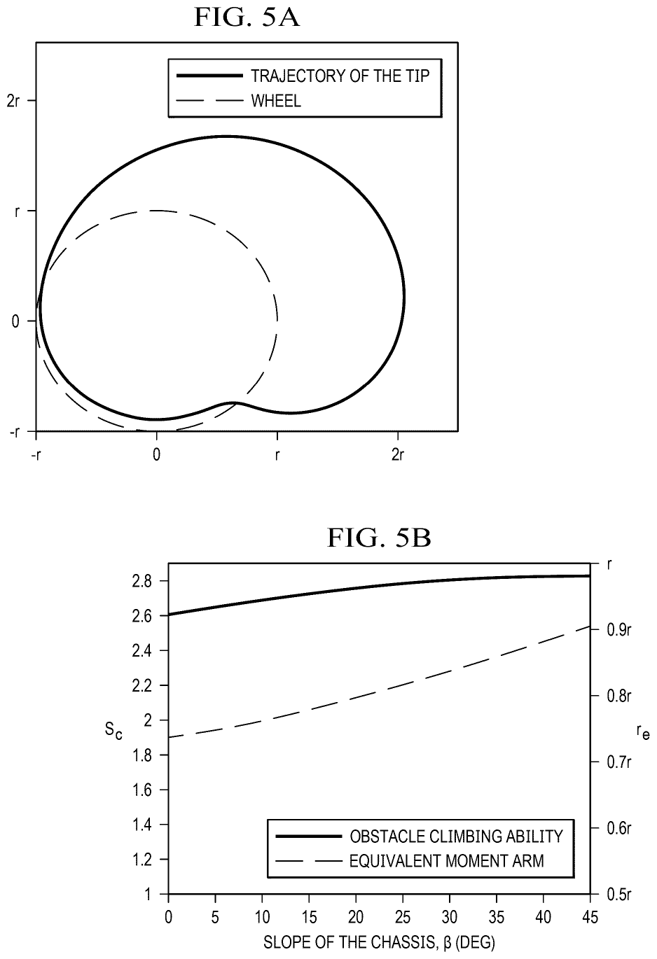

The selected design candidate was evaluated for the trajectory of the leg tip position (Pₜ) along θ and the reachable tip height over the slope angle β. As shown in FIG. 5A, the trajectory of Pₜ (shown in solid line) shows that the tip stretches out of the wheel boundary (shown in dashed line) to engage an obstacle in the forward direction. It also shows that the tip folds back near the ground and remains within the wheel boundary, ensuring the mechanism rolls with a wheel on a horizontal plane.

To evaluate the climbing ability of the CLAW mechanism, a value was adopted for Sc, which was defined as Equation (22):

$${S}_{c} ≡ \frac{{h}_{max}}{r} \qquad Eq . ( 22 )$$

where hₘₐₓ is the maximum reachable height of the leg tip. The solid line in FIG. 5B shows the S_{c} values corresponding to 0≤β≤max(=π/4). On a flat surface (β=0), the selected design achieves S_{c}=2.60. The climbing ability score slightly increases as β does and achieves S_{c}=2.83 when β=π/4. These S_{c} values are higher or comparable to previously developed passive transformable wheels (e.g., values of S_{c}=2.34, 2.4, 2.5, 2.8, and 3.25).

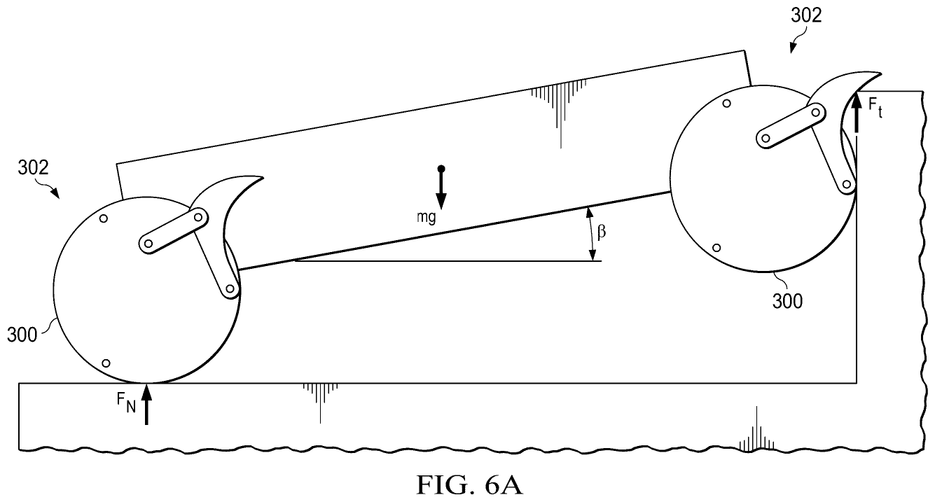

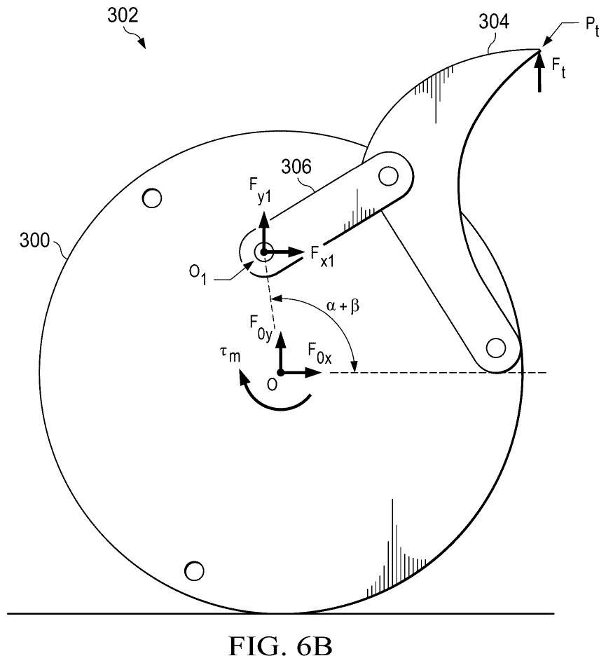

Assuming that the external force Fₜ applied to the leg's tip is perpendicular to the contact surface, the equivalent moment arm for estimating the stall torque is defined in Equation (23):

$${r}_{e} ≡ \frac{{τ}_{s}}{{F}_{t}} \qquad Eq . ( 23 )$$

where τₛ is the motor output torque. FIG. 6A illustrates a robot, such as robot 100, utilizing wheels 300 to climb an obstacle. FIG. 6B is a freebody diagram of wheel 300. As shown in FIG. 6A, Fₜ depends on the position of the center of gravity and robot 100's weight. For wheel 300 as shown in FIG. 6B, the mass of the leg 302 is assumed to be negligible. The coordinate of ^{g}Pₜ at the maximum height is given by Equation (24):

$${}_{}^{g} {P}_{t}^{} = {[ {x}_{t}^{*} , {y}_{t}^{*} , 0 ]}^{T} \qquad Eq . ( 24 )$$

The coordinate of O₁ in f_{g} is expressed as Equation (25):

$${}_{}^{g} {O}_{1}^{} = {[ {x}_{1} , {y}_{1} , 0 ]}^{T} \qquad Eq . ( 25 )$$

where x₁=d₁ cos (β+α) and y₁=d₁ sin (β+α). When wheel 300 is stationary, the sum of the moments on each joint must be zero, such that ΣM_{O}=0, ΣM_{O1}=0, and ΣM_{Pt}=0. The sum of all forces that are applied to x and y axis is also zero, such that ΣFₓ=0 and ΣF_{y}=0. These are expressed in a matrix form in Equation (26) below:

$$[ \begin{matrix}- 1 & 0 & 0 & - {y}_{1} & {x}_{1} \\ - 1 & {y}_{t}^{*} & - {x}_{1} & 0 & 0 \\ - 1 & {y}_{t}^{*} - {y}_{1} & {x}_{1} - {x}_{t}^{*} & {y}_{t}^{*} & - {x}_{t}^{*} \\ 0 & 1 & 0 & 1 & 0 \\ 0 & 0 & 1 & 0 & 1\end{matrix} ] [ \begin{matrix}τ \\ {F}_{Ox} \\ {F}_{Oy} \\ {F}_{x 1} \\ {F}_{y 1}\end{matrix} ] = [ \begin{matrix}- {F}_{t} {x}_{t}^{*} \\ {F}_{t} ( {x}_{1} - {x}_{t}^{*} ) \\ 0 \\ 0 \\ - {F}_{t}\end{matrix} ] \qquad Eq . ( 26 )$$

As presented in FIG. 6B, F_{Ox} and F_{Oy} are applied to the joint O; Fₓ₁ and F_{y1} are the forces applied to the joint O₁ along the x- and y-axis. The stall torque τₛ can be calculated from (26). The equivalent moment arm for the given stall torque is then obtained using (23). The relation between rₑ and β is shown in FIG. 5B (dashed line). As β increases, rₑ also increases, indicating a higher stall torque required.

### Mobile Robot Embodiment

This section introduces the engineered design of the CLAW mechanism based on the optimization results, and describes the construction and development of a four-wheeled robot that incorporates these mechanisms as its locomotion system.

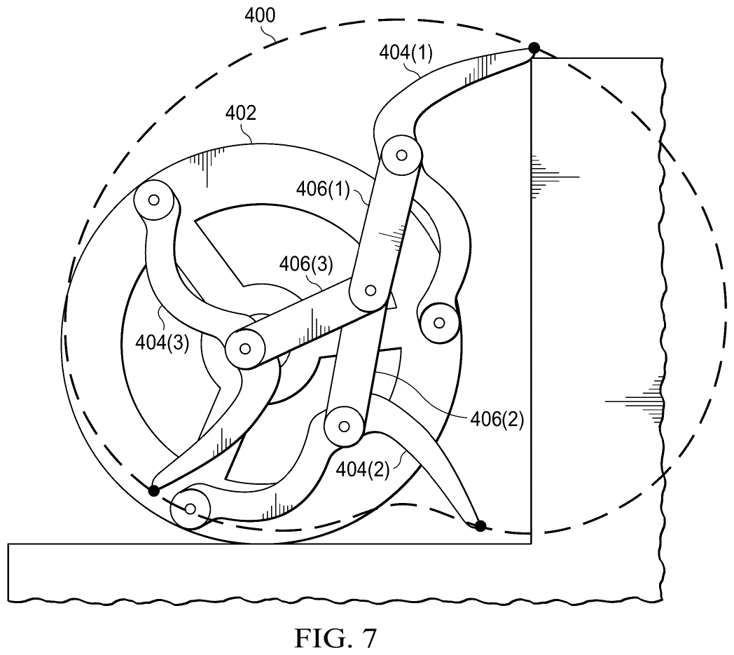

After analyzing the optimization results, a design for a CLAW mechanism was selected for hardware prototyping and implementation as a robot embodiment. FIG. 7 illustrates a CLAW mechanism 400 that includes a wheel 402 with three legs 404(1)-404(3) movably secured thereto via three linkages 406(1)-406(3), similar to the discussion of mechanism 102 relative to FIGS. 2A-2D. The tips of each leg 404 follows the same trajectory, ensuring two legs (e.g., legs 404(2) and 404(3)) fold back and remain apart from the obstacle and the ground while one leg (e.g., 404(1)) is extended out for climbing. r=10 cm was selected for hardware implementation. This allows the mechanism to climb over 26 cm in height when β=0, and 28 cm when β=π/4, which are sufficient for most stairs. By carefully considering the geometric configuration and leg trajectory, a curved design (e.g., see FIG. 7) was adopted for each leg 404 to guarantee seamless and unobstructed movement during rotation. For rapid prototyping, both wheel 402 and the legs 404 were fabricated via 3D printing using polylactide acid (PLA). Other methods of manufacture could be used as desired. Both wheel 402 and legs 404 have a thickness of 3 cm. Legs 404 have an average width of 1.5 cm, and the width of linkages 406 is 2 cm. It is noted that different thickness and width values can be used depending on the materials and necessary strength and durability. A tire or a pad can be added to the wheel and the leg tips for improved traction and shock absorption as desired. In some aspects, a commercial wheel can be used and mechanism 400 can be added as a retrofit.

In mechanism 400, both axial points O and O₁ are fixed with respect to the robot chassis. The axis O serves as the rotating axis, directly connected to the shaft of the driving motor. The axis O₁ must be attached to the chassis in a manner that does not obstruct the rotational motion of the entire mechanism, and the structure connecting O₁ to the chassis must endure high stiffness. To fulfill this requirement, an aluminum beam was used to offer greater stiffness compared to the 3D-printed PLA. Additionally, aluminum has a relatively low weight and cost compared to alternatives, such as steel or carbon fiber.

### Hardware Development

The robot's chassis was built using an aluminum frame covered by an acrylic sheet from the top (e.g., see FIGS. 1A-1C). The overall dimension of the chassis was about 72.0×45.1×4.8 cm³, where the wheelbase is 50.4 cm and the track is 45.6 cm. Table 3 lists the specific dimensions of CLAWbot and the CLAW mechanism. Within the chassis, custom-designed 3D-printed housings were integrated to hold the batteries and embedded electronic components securely.

TABLE 3
Specifications of mobile robot

| Notation | Description | Value | |
|---|---|---|---|
| L_{c} | Length of the chassis | 50.4 | cm |
| W_{c} | Width of the chassis | 45.6 | cm |
| H_{c} | Height of the chassis | 18.2 | cm |
| r | Wheel radius | 10 | cm |
| lₒ | Length of O̅P̅₀̅ | 8.916 | cm |
| d₁ | Length of O̅O̅₁̅ | 5.918 | cm |
| l₁ | Length of O̅₁̅P̅₁̅ | 6.514 | cm |
| d₂ | Length of P̅₀̅P̅₁̅ | 8.486 | cm |
| ¹xₜ | x coordinate of point Pₜ in f₁ | 7.842 | cm |
| ¹yₜ | y coordinate of point Pₜ in f₁ | 12.23 | cm |
| α | Angle between x₀ and O̅O̅₁̅ | 0.4595 | radian |
| t_{w} | Thickness of the wheel and leg | 3 | cm |
| wₗ | Width of the leg | 1.5 | cm |
| wᵣ | Width of the connection rod | 2 | cm |
| m | Weight of the robot | 8.76 | kg |

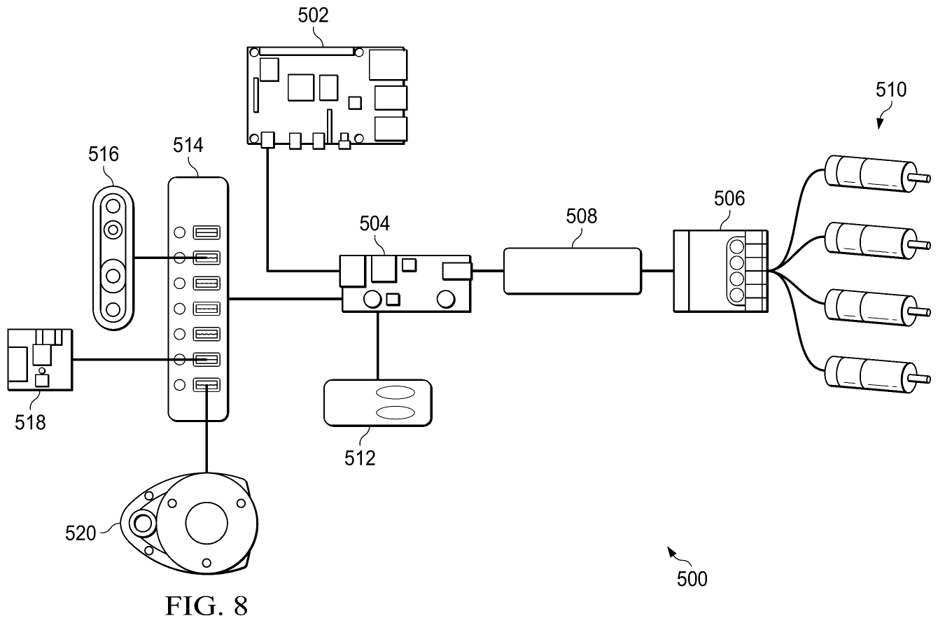

FIG. 8 is a system diagram 500 illustrating the various embedded sensors, processing boards, actuators, and the like for use with the various robot systems discussed herein. Components include, for example, a processor 502, a DC regulator 504, a motor controller 506, a battery 508, a plurality of motors 510, a network module 512, and a USB hub 514. Various components can be connected to and/or powered by USB hub 514, such as a camera 516, an IMU/GPS module 518, and a Lidar system 520. Additional components can be integrated into diagram 500 depending on the use case.

The technical specifications of these components are provided below:
Processor 502: Raspberry Pi 4 Model B (RPi4) with 8 GB RAM with quad-core Cortex-A72 (ARM v8) 1.5 GHz 64-bit CPU.
Camera 516: RGB-D Camera, Intel Realsense D435i camera.
IMU/GPS 518: IMU+GPS, a customized board with a BNO055 inertial measurement unit (IMU), an Adafruit Ultimate Global Positioning System (GPS), and a Teensy 4.0 microcontroller that collects and sends data.
Lidar system 520: RP-Lidar A1—a light detection and ranging sensor with 360° angle.
Network module 512: Mesh Network Module, Rajant DX series device (Rajant Inc.) for long-range wireless connection via a mesh network.
DC regulator 504: 5V DC Regulator, DC input 9-36V, output 5V UCTRON-ICS DC power regulator that powers the main processor and all sensors.
Motor controller 506: Motor Controller, Basicmicro Roboclaw motor controllers with a maximum current of 30 A
Motors 510: 188:1 gear ratio, 30 RPM, planetary gear DC motors.
Battery 508: 5200 mAh 4-cell Lithium Polymer (LiPo) battery.

Processor 502 of CLAWbot collects the data from all embedded sensors via USB hub 514. Processor 502 operates on, for example, the Ubuntu 22.04 operating system, with ROS2 Humble installed to manage the data and algorithms. Two 2.4 GHz antennas are installed on the left side of the chassis frame. These antennas are connected to network module 512, which establishes network connections. Network module 512 passes the network connections to processor 502 using, for example, an Ethernet cable. On the top of the robot, a navigation sensor suite houses the IMU/GPS module 518, and Lidar system 520. Camera 516 is positioned on the robot chassis to capture visual data.

With all the embedded hardware components discussed above, the robot weighs about 8.76 kg. The center of gravity is approximately located at the geometric center of the robot. As the robot is equipped with four CLAW mechanisms, each is subjected to a force of (8.76×9.8)/4=21.462 N. If this force is exerted on a single leg tip, the resulting force becomes Fₜ=21.462 N. Referring to FIG. 5B, the motor must withstand a minimum stall torque, which can be calculated as Equation (27):

$${τ}_{s} = {F}_{t} \cdot max ( {r}_{e} ) = {F}_{t} \cdot 0.91 r = 1.95 N \cdot m \qquad Eq . ( 27 )$$

The theoretical minimum stall torque required for the motor is 1.95 N.m. Motors 510 with a significantly higher torque rating were selected to account for potential increases in payloads and operation speed. This ensures that motors 510 can handle the expected load and perform optimally, even under more challenging conditions.

### Experimental Evaluation of Mobility

The overall mobility of the robot was evaluated for obstacle climbing, stair climbing, and multi-terrain mobility. All robots employed for experiments were equipped with an absolute orientation sensor (i.e., BNO055) to measure the yaw, pitch, and roll angles based on the North-East-Down (NED) standard.

The robot's ability to climb over a right-angled obstacle was tested with a varying height from a flat surface. In this test, the robot was manually controlled to move forward at 0.12 meters per second (m/s). A successful trial required the entire wheels of the robot to overcome the obstacle. The obstacle height varied from 22 to 30 cm with a 1 cm increment. The climbing test was repeated 20 times for each obstacle height. The results are summarized in Table 4. The success rate was 100% up to h=23 cm, 90% for h=24 and 25, and 75% for h=26. The success rate dropped below 50% afterward. The experimental results were consistent with the computational estimation of hₘₐₓ=2.6r described above. Obstacles with over 50% success rate are considered climbable because the robot can back up and retry to traverse the obstacle more than once.

TABLE 4
Obstacle Height (cm) vs. Success Rate (%) From 20 Trials

| | | | | | | | | | |
|---|---|---|---|---|---|---|---|---|---|
| Height | 22 | 23 | 24 | 25 | 26 | 27 | 28 | 29 | 30 |
| Success rate | 100 | 100 | 90 | 90 | 75 | 45 | 20 | 0 | 0 |

The robot was further tested for its stair-climbing ability. It was remotely operated at the same speed as in the obstacle-climbing tests. Four staircases on the Texas A&M University campus were selected for testing. These staircases feature distinctive geometries: (a) 12 cm raise x 40 cm tread (the estimated body slope β=0.29 rad), (b) 15×31 (β=0.45), (c) 16×28 (β=0.52), and (d) 18×31 (β=0.53). On each staircase, the robot repeatedly ascended to the top and descended to the ground three times. It effectively utilized the legs when climbing and exhibited wheeled locomotion when moving down the stairs. Notably, the robot achieved a 100% success rate traversing all four staircases. These results emphasize the effectiveness and reliability of the robot's stair-climbing capabilities.

The robot underwent additional mobility evaluations across diverse terrains. The robot was remotely controlled to move forward and backward at 0.3 m/s and turn left and right at 0.5 rad/s on a concrete floor, grass, and a rocky surface. The robot demonstrated mobility and maneuverability on all tested surfaces like a conventional wheeled robot. On the rocky surface, the robot occasionally utilized the legs when encountering larger rocks.

### Comparative Analyses

A α-WaLTR, a robot utilizing the CLAW mechanism, and a conventional wheeled robot were employed for comparative evaluations. One of the expected advantages of the CLAW mechanism design is smooth climbing compared to some other passive wheel-leg mechanisms. After the legs of the front wheels of the robot using the CLAW mechanism effectively overcame the obstacle, the circular wheels maintained contact with the surface while the rear legs engaged in climbing. On the other hand, the front wheels in a-WaLTR were transformed when encountered by an obstacle and remained in the legged configuration as the rear wheels approached the obstacle and also transformed into legs. Observing the pitch angles over time as the two robots climbed over the same obstacle, the robot using the CLAW mechanism exhibited a much smoother trajectory than α-WaLTR.

The turning motion of the robot using the CLAW mechanism compared to α-WaLTR and a conventional four-wheeled robot was also analyzed. Passive transformation mechanisms, like WheeLeR used in α-WaLTR, often experience undesirable turning behavior when used in a fixed-axis, four-wheeled robot configuration. In such robots, turning or moving on a curve results in different friction applied to the left and right sides of the wheels, leading to one side transforming into legs while the other remains as wheels, as observed in α-WaLTR. The robot using the CLAW mechanism and α-WaLTR are similar in their chassis and wheel sizes. The wheeled robot, custom-built from a commercial chassis (AION-R1), was smaller (45.5×42.6×17.7 cm³) than the other two. Each of the robot were controlled to rotate on a flat concrete surface at the same angular speed of 0.5 rad/s. The robot using the CLAW mechanism showed a similar trend in the rolling angles as the wheeled robot, while α-WaLTR followed a bumpy trajectory due to one side of the wheels transforming into the legged configuration during turning.

Compared to other existing transformable or integrated mechanisms, the robot using the CLAW mechanism exhibited comparable or better climbing performance. It reached over 2.6 of its wheel radius, which is comparable to or higher than many existing wheel-leg mechanisms. According to the mechanical complexity measured by C=Nₐ·Nⱼ, where Nₐ is the number of actuators, and Nⱼ is the number of joints, CLAW has lower complexity (C=8) than most active mechanisms (e.g., FUHAR with C=28, armadillo-inspired wheel-Leg robot with C=12, and claw-wheel transformable robot with C=9) as well as many passive mechanisms (e.g., IMS robot with C=10 and Wheel Transformer with C=9). Only a few passive mechanisms, such as WheeLeR (C=4) and swing-grouser wheel (C=7), exhibited lower mechanical complexity than the CLAW mechanism. It was noted that these passive mechanisms with a lower C exhibit the transformation uncertainty, while the CLAW mechanism does not.

### Conclusion and Discussion

The CLAW mechanism is a novel wheel-leg integrated mechanism consisting of a wheel with three leg segments assembled with a unique bar mechanism. The design was optimized to maximize the leg's reachable height when extended and not to touch the ground when it folds back to ensure effective scaling over obstacles while maintaining smooth rolling on flat surfaces. The CLAW mechanism design can be retrofit to existing wheels on vehicles without replacing them. It can also be installed on a tracked robot and can be used for a robot with any number of wheels, such as two-, four-, or six-wheeled platforms.

Building on the presented work on the mechanism design, hardware construction, and mobility evaluations, ongoing research focuses on developing autonomous control algorithms to take advantage of the advanced mobility offered by the CLAW mechanism. Robots employing the CLAW mechanism operate as a wheeled robots, and thus can utilize a vast amount of existing research on wheeled robot control, localization, and navigation. Advanced climbing abilities of the CLAW mechanism enable the robot to traverse challenging terrains and obstacles, such as stairs and rough surfaces, which are typically considered non-traversable for a conventional wheeled robot. To equip the robot with platform-specific capabilities, it requires an additional set of algorithms for terrain classification, stair detection, and stair/obstacle climbing.

Derivation of Solutions for x_{P}_{₁} and y_{P}_{₁}

Two sets of solutions exist for x_{P}_{₁} and y_{P}_{₁}. The position of P₁ must remain on the same side as the wheel rotate 0≤θ<2π.

When sin

$$θ = \frac{{d}_{1} sin σ}{{l}_{o}} , \qquad Equation ( 28 )$$

$${x}_{P 1} = \frac{{l}_{0}^{2} + {l}_{1}^{2} - {d}_{1}^{2} - {d}_{2}^{2}}{2 ( {l}_{0} cos θ - {d}_{1} cos α )} \qquad Eq . ( 28 )$$

In this case, the solutions for yP1 have two different conditions. When

$$θ = arcsin ( \frac{{d}_{1} sin α}{{l}_{o}} ) ,$$

### Equation (29):

$${y}_{P 1} = \frac{- {b}_{y} + \sqrt{{b}_{y}^{2} - {4}_{Cy}}}{2} \qquad Eq . ( 29 )$$

When

$$θ = π - arcsin ( \frac{{d}_{1} sin α}{{l}_{o}} ) , \qquad Equation ( 30 )$$

$${y}_{P 1} = \frac{- {b}_{y} - \sqrt{{b}_{y}^{2} - {4}_{Cy}}}{2} \qquad Eq . ( 30 )$$

When sin

$$θ \neq \frac{{d}_{1} sin α}{{l}_{o}} ,$$

there are two conditions for x_{P}_{₁}. When θ is in the range

$$\frac{{d}_{1} sin α}{{l}_{o}} < θ < π - arcsin \frac{{d}_{1} sin α}{{l}_{o}} , \qquad Equation ( 31 )$$

$${x}_{P 1} = \frac{- {b}_{x} - \sqrt{{b}_{x}^{2} - 4 {a}_{x} {c}_{x}}}{2 {a}_{x}} \qquad Eq . ( 31 )$$

Otherwise, Equation (32):

$${x}_{P 1} = \frac{- {b}_{x +} \sqrt{{b}_{x}^{2} - 4 {a}_{x} {c}_{x}}}{2 {a}_{x}} \qquad Eq . ( 32 )$$

The corresponding solution for y_{P}_{₁} is Equation (33):

$${y}_{P 1} = {A}_{1} {x}_{P 1} + {A}_{2} \qquad Eq . ( 33 )$$

Where Equations (34)-(40):

$${A}_{1} = \frac{{l}_{0} cos θ - {d}_{1} cos α}{{d}_{1} sin α - {l}_{0} sin θ} \qquad Eq . ( 34 )$$

$${A}_{2} = \frac{{d}_{2}^{2} + {d}_{1}^{2} - {l}_{0}^{2} - {l}_{1}^{2}}{2 ( {d}_{1} sin α - {l}_{0} sin θ )} \qquad Eq . ( 35 )$$

$${a}_{x} = 1 + {A}_{1}^{2} \qquad Eq . ( 36 )$$

$${b}_{x} = 2 {A}_{1} {A}_{2} - 2 {d}_{1} cos α - 2 {d}_{1} {A}_{1} sin α \qquad Eq . ( 37 )$$

$${c}_{x} = {A}_{2}^{2} - 2 {d}_{1} {A}_{2} sin α - {l}_{1}^{2} - {l}_{1}^{2} \qquad Eq . ( 38 )$$

$${b}_{y} = - 2 {d}_{1} sin α \qquad Eq . ( 39 )$$

$${c}_{y} = {x}_{P 1}^{2} - 2 {d}_{1} {x}_{P 1} cos α + {d}_{1}^{2} - {c}_{1}^{2} \qquad Eq . ( 40 )$$

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A leg-augmented wheel assembly comprising:
a wheel;
a first leg member comprising a first end connected to the wheel; and
a first link comprising a first end connected to the first leg member, the connection of the first link to the leg first member being configured to periodically extend the first leg member as the wheel rotates.

2. The augmented wheel assembly of claim 1, wherein the first leg member comprises a second end configured to extend outward from the wheel boundary as the wheel rotates to traverse obstacles encountered by the wheel.

3. The augmented wheel assembly of claim 2, wherein the second end of the first leg member is configured to retract to a radius less than or equal to the radius of the wheel at a point where the wheel contacts a surface upon which the wheel rotates.

4. The augmented wheel assembly of claim 2, wherein the first end of the first link connects to the first leg member at a point between the first leg member's first and second end.

5. The augmented wheel assembly of claim 1, wherein the second end of the first leg is configured to extend greater than two times the diameter of the wheel.

6. The augmented wheel assembly of claim 1, further comprising:
second and third leg members; and
second and third links,
wherein:
the second link comprises a first end connected the second leg member;
the third link comprises a first end connected to the third leg member; and
second ends of the first, second, and third links are connected together.

7. A leg-augmented wheel assembly comprising:
a plurality of links; and
a plurality of leg members, each leg member of the plurality of leg members comprising a first end connected to a link of the plurality of links and a second end comprising a curved edge that is configured to allow a wheel of the wheel assembly to make contact with a surface upon which the leg-augmented wheel assembly rotates during a portion of a cycloidal rotation of the leg member,
wherein each link comprises a first end connected to one leg member of the plurality of leg members and a second end connected to each other link of the plurality of links.

8. The leg-augmented wheel assembly of claim 7, wherein the second end of each leg member comprises a portion configured to extend outward from a boundary of the wheel as the wheel rotates to traverse obstacles encountered by the wheel.

9. The leg-augmented wheel assembly of claim 7, wherein the second end of each leg member is configured to retract to a radius less than or equal to the radius of the wheel at a point where the wheel contacts a surface upon which the wheel rotates.

10. The leg-augmented wheel assembly of claim 7, wherein the portion is configured to extend beyond the twice of the length of an arm of the plurality of arms.

11. A robot comprising a plurality of the leg-augmented wheel assemblies of claim 1.

12. A leg-augmented wheel assembly comprising:
a wheel;
at least one leg member, each leg member comprising a first end connected to the wheel; and
a link for each leg member, each link comprising a first end connected to one leg member of the at least one leg member and a second end connected to one of a second end of an additional link or the wheel.

13. The leg-augmented wheel assembly of claim 12, wherein the at least one leg member comprises a second end configured to extend outward from the wheel as the wheel rotates to traverse obstacles encountered by the wheel.

14. The leg-augmented wheel assembly of claim 13, wherein the second end of the at least one leg member is configured to retract to a radius less than or equal to the radius of the wheel at a point where the wheel contacts a surface upon which the wheel rotates.

15. The leg-augmented wheel assembly of claim 12, wherein the second end is configured to extend greater than two times the diameter of the wheel.
